(19) United States
(12) Patent Application Publication
(10) Pub. No.: US 2024/0161740 A1
(43) Pub. Date: May 16, 2024

(54) Multi-Assistant Warm Words

(71) Applicant: Google LLC, Mountain View, CA (US)

(72) Inventors: Matthew Sharifi, Kilchberg (CH); Victror Carbune, Zurich (CH)

(73) Assignee: Google LLC, Mountain View, CA (US)

(21) Appl. No.: 18/055,395

(22) Filed: Nov. 14, 2022

(51) Int. Cl. G10L 15/22; G10L 15/08

(52) U.S. Cl. CPC G10L 15/22; G10L 15/08; G10L 2015/088

(57) ABSTRACT

A method using multi-assistant warm words includes, for each digital assistant in a group of digital assistants enabled on a multi-assistant device, receiving a respective active set of warm words that each specify a respective action to perform. Based on the respective active set of warm words, the method also includes executing a warm word arbitration routine to enable a final set of warm words for detection, each warm word in the final set of warm words selected from the respective active set of warm words for at least one digital assistant. While the final set of warm words are enabled for detection, the method includes receiving audio data corresponding to an utterance, detecting a warm word from the final set of warm words, and instructing the digital assistant associated with the detected warm word to perform the respective action specified by the detected warm word.

### CROSS REFERENCE TO RELATED APPLICATIONS

### Technical Field

This disclosure relates to multi-assistant warm words.

### BACKGROUND

A speech-enabled environment permits a user to only speak a query or command out loud and a digital assistant will field and answer the query and/or cause the command to be performed. A speech-enabled environment (e.g., home, workplace, school, etc.) can be implemented using a network of connected microphone devices distributed throughout various rooms and/or areas of the environment. Through such a network of microphones, a user has the power to orally query the digital assistant from essentially anywhere in the environment without the need to have a computer or other device in front of him/her or even nearby. For example, while cooking in the kitchen, a user might ask the digital assistant “please set a timer for 20-minutes” and, in response, the digital assistant will confirm that the timer has been set (e.g., in a form of a synthesized voice output) and then alert (e.g., in the form of an alarm or other audible alert from an acoustic speaker) the user once the timer lapses after 20-minutes. Often, there are multiple digital assistants activated simultaneously on a given device that users in a given environment can query/command to perform various actions. Each of these digital assistants may have its own set phrases (i.e., warm words) that are detectable in speech without performing full speech recognition, and may overlap with one or more phrases of another digital assistant activated on the device. For instance, a user of the multiple digital assistants might speak the command “play music”, which may correspond to both a music digital assistant and a browser digital assistant. In response, the appropriate digital assistant can stream a music playlist for the user through an acoustic speaker.

### SUMMARY

One aspect of the disclosure provides a computer-implemented method that when executed on data processing hardware causes the data processing hardware to perform operations that include, for each respective digital assistant in a group of digital assistants enabled for simultaneous execution on a multi-assistant device (MAD), receiving a respective active set of warm words that each specify a respective action for the respective digital assistant to perform. Based on the respective active set of warm words associated with each digital assistant in the group of digital assistants, the method also includes executing, by a multi-assistant interface executing on the MAD, a warm word arbitration routine to enable a final set of warm words for detection by the MAD. Each corresponding warm word in the final set of warm words that is enabled for detection by MAD is selected from the respective active set of warm words for at least one digital assistant in the group of digital assistants. While the final set of warm words are enabled for detection by the MAD, the method further includes receiving audio data corresponding to an utterance captured by the MAD, detecting, in the audio data, a warm word from the final set of warm words, and instructing, from the group of digital assistants, the digital assistant associated with the detected warm word to perform the respective action specified by the detected warm word.

Implementations of the disclosure may include one or more of the following optional features. In some implementations, receiving the respective active set of warm words associated with the digital assistant includes receiving, for at least one warm word in the respective active set of warm words, via a warm word application programming interface (API) executing on the MAD, a respective warm word model configured to detect the corresponding warm word in streaming audio without performing speech recognition. In some examples, for a corresponding one of the digital assistants in the group of digital assistants, the operations further include receiving a user command specifying a long-standing operation for the corresponding digital assistant to perform, and performing, via the corresponding digital assistant, the long-standing operation specified by the voice command. Here, receiving the respective active set of warm words associated with the digital assistant includes receiving, in response to the corresponding digital assistant performing the long-standing operation, the respective active set of warm words associated with the corresponding digital assistant. In these examples, each warm word in the respective active set of warm words may be associated with a respective action for controlling the long-standing operation performed by the corresponding digital assistant.

In some implementations, the operations further include discovering a new digital assistant in the group of digital assistants enabled for simultaneous execution on the MAD, where the multi-assistant interface executes the warm word arbitration routine in response to discovering the new digital assistant in the group of digital assistants. In some examples, the operations further include determining that a digital assistant has been removed from the group of digital assistants enabled for simultaneous execution on the MAD. Here, the multi-assistant interface executes the warm word arbitration routine in response to determining that the digital assistant has been removed from the group of digital assistants. In some implementations, for a corresponding one of the digital assistants in the group of digital assistants, the operations further include determining an addition of a warm word or a removal of a warm word in the respective active set of warm words associated with the corresponding digital assistant. In these implementations, the multi-assistant interface executes the warm word arbitration routine in response to determining the addition of the warm word or the removal of the warm word in the respective set of warm words.

In some examples, the operations further include determining a change in ambient context, where the multi-assistant interface executes the warm word arbitration routine in response to determining the change in ambient context. In some implementations, the operations further include obtaining enabled warm word constraints. In these implementations, the enabled warm word constraints include at least one of memory and computing resource availability on the MAD for detection of warm words, computational requirements for enabling each warm word in respective active set of warm words associated with each respective digital assistant in the group of digital assistants, an acceptable false accept rate tolerance, or an acceptable false reject rate tolerance. Here, a number of the warm words in the final set of warm words enabled for detection by the MAD is based on the obtained active warm word constraints. In some examples, executing the warm word arbitration routine includes identifying any shared warm words corresponding to warm words present in at least two of the active sets of warm words, and determining the final set of warm words is based on assigning a higher priority to warm words identified as shared warm words.

In some implementations, executing the warm word arbitration routine includes, for each warm word in the respective active set of warm words for each respective digital assistant in the group of digital assistants, determining a frequency of detection of the warm word by the MAD. In these implementations, determining the final set of warm words is based on the determined frequency of detection of each warm word in the respective active set of warm words for each respective digital assistant in the group of digital assistants. In some examples, executing the warm word arbitration routine includes, for each warm word in the respective active set of warm words for each respective digital assistant in the group of digital assistants, determining a time when the warm word was most recently detected by the MAD. Here, determining the final set of warm words is based on the determined time that each warm word in the respective active set of warm words for each respective digital assistant in the group of digital assistants was most recently detected.

In some implementations, the operations further include receiving a voice command that commands the MAD to enable a first digital assistant and a second digital assistant to execute simultaneously on the MAD. Here, the voice command is spoken by a user of the MAD and captured by the MAD in streaming audio. In these implementations, after receiving the voice command, the operations further include enabling the first digital assistant and the second digital assistant to execute simultaneously with one another on the MAD, where the group of digital assistants includes the first digital assistant and the second digital assistant. In some examples, the operations further include receiving, from a software application executing on the MAD or another device in communication with the MAD, a multi-assistant configuration request to enable a first digital assistant and a second digital assistant to execute simultaneously on the MAD. In these examples, after receiving the multi-assistant configuration request, the operations also include enabling the first digital assistant and the second digital assistant to execute simultaneously with one another on the MAD, where the group of digital assistants includes the first digital assistant and the second digital assistant.

Another aspect of the disclosure provides a system including data processing hardware and memory hardware in communication with the data processing hardware. The memory hardware stores instructions that when executed by the data processing hardware cause the data processing hardware to perform operations that include, for each respective digital assistant in a group of digital assistants enabled for simultaneous execution on a multi-assistant device (MAD), receiving a respective active set of warm words that each specify a respective action for the respective digital assistant to perform. Based on the respective active set of warm words associated with each digital assistant in the group of digital assistants, the method also includes executing, by a multi-assistant interface executing on the MAD, a warm word arbitration routine to enable a final set of warm words for detection by the MAD. Each corresponding warm word in the final set of warm words that is enabled for detection by MAD is selected from the respective active set of warm words for at least one digital assistant in the group of digital assistants. While the final set of warm words are enabled for detection by the MAD, the method further includes receiving audio data corresponding to an utterance captured by the MAD, detecting, in the audio data, a warm word from the final set of warm words, and instructing, from the group of digital assistants, the digital assistant associated with the detected warm word to perform the respective action specified by the detected warm word.

This aspect may include one or more of the following optional features. In some implementations, receiving the respective active set of warm words associated with the digital assistant includes receiving, for at least one warm word in the respective active set of warm words, via a warm word application programming interface (API) executing on the MAD, a respective warm word model configured to detect the corresponding warm word in streaming audio without performing speech recognition. In some examples, for a corresponding one of the digital assistants in the group of digital assistants, the operations further include receiving a user command specifying a long-standing operation for the corresponding digital assistant to perform, and performing, via the corresponding digital assistant, the long-standing operation specified by the voice command. Here, receiving the respective active set of warm words associated with the digital assistant includes receiving, in response to the corresponding digital assistant performing the long-standing operation, the respective active set of warm words associated with the corresponding digital assistant. In these examples, each warm word in the respective active set of warm words may be associated with a respective action for controlling the long-standing operation performed by the corresponding digital assistant.

In some implementations, the operations further include discovering a new digital assistant in the group of digital assistants enabled for simultaneous execution on the MAD, where the multi-assistant interface executes the warm word arbitration routine in response to discovering the new digital assistant in the group of digital assistants. In some examples, the operations further include determining that a digital assistant has been removed from the group of digital assistants enabled for simultaneous execution on the MAD. Here, the multi-assistant interface executes the warm word arbitration routine in response to determining that the digital assistant has been removed from the group of digital assistants. In some implementations, for a corresponding one of the digital assistants in the group of digital assistants, the operations further include determining an addition of a warm word or a removal of a warm word in the respective active set of warm words associated with the corresponding digital assistant. In these implementations, the multi-assistant interface executes the warm word arbitration routine in response to determining the addition of the warm word or the removal of the warm word in the respective set of warm words.

In some examples, the operations further include determining a change in ambient context, where the multi-assistant interface executes the warm word arbitration routine in response to determining the change in ambient context. In some implementations, the operations further include obtaining enabled warm word constraints. In these implementations, the enabled warm word constraints include at least one of memory and computing resource availability on the MAD for detection of warm words, computational requirements for enabling each warm word in respective active set of warm words associated with each respective digital assistant in the group of digital assistants, an acceptable false accept rate tolerance, or an acceptable false reject rate tolerance. Here, a number of the warm words in the final set of warm words enabled for detection by the MAD is based on the obtained active warm word constraints. In some examples, executing the warm word arbitration routine includes identifying any shared warm words corresponding to warm words present in at least two of the active sets of warm words, and determining the final set of warm words is based on assigning a higher priority to warm words identified as shared warm words.

In some implementations, executing the warm word arbitration routine includes, for each warm word in the respective active set of warm words for each respective digital assistant in the group of digital assistants, determining a frequency of detection of the warm word by the MAD. In these implementations, determining the final set of warm words is based on the determined frequency of detection of each warm word in the respective active set of warm words for each respective digital assistant in the group of digital assistants. In some examples, executing the warm word arbitration routine includes, for each warm word in the respective active set of warm words for each respective digital assistant in the group of digital assistants, determining a time when the warm word was most recently detected by the MAD. Here, determining the final set of warm words is based on the determined time that each warm word in the respective active set of warm words for each respective digital assistant in the group of digital assistants was most recently detected.

In some implementations, the operations further include receiving a voice command that commands the MAD to enable a first digital assistant and a second digital assistant to execute simultaneously on the MAD. Here, the voice command is spoken by a user of the MAD and captured by the MAD in streaming audio. In these implementations, after receiving the voice command, the operations further include enabling the first digital assistant and the second digital assistant to execute simultaneously with one another on the MAD, where the group of digital assistants includes the first digital assistant and the second digital assistant. In some examples, the operations further include receiving, from a software application executing on the MAD or another device in communication with the MAD, a multi-assistant configuration request to enable a first digital assistant and a second digital assistant to execute simultaneously on the MAD. In these examples, after receiving the multi-assistant configuration request, the operations also include enabling the first digital assistant and the second digital assistant to execute simultaneously with one another on the MAD, where the group of digital assistants includes the first digital assistant and the second digital assistant.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A-1C are schematic views of an example system including a user controlling a long-standing operation using multi-assistant warm words.

FIG. 2 is a schematic view of a multi-assistant warm word detection process.

FIG. 3 is a flowchart of an example arrangement of operations for a method for using multi-assistant warm words.

FIG. 4 is a schematic view of an example computing device that may be used to implement the systems and methods described herein.

Like reference symbols in the various drawings indicate like elements.

### DETAILED DESCRIPTION

A user's manner of interacting with an assistant-enabled device is designed to be primarily, if not exclusively, by means of voice input. Consequently, the assistant-enabled device must have some way of discerning when any given utterance in a surrounding environment is directed toward the device as opposed to being directed to an individual in the environment or originating from a non-human source (e.g., a television or music player). One way to accomplish this is to use a hotword, which by agreement among the users in the environment, is reserved as a predetermined word(s) that is spoken to invoke the attention of the device. In an example environment, the hotword used to invoke the assistant's attention are the words “OK computer.” Consequently, each time the words “OK computer” are spoken, it is picked up by a microphone, conveyed to a hotword detector, which performs speech understanding techniques to determine whether the hotword was spoken and, if so, awaits an ensuing command or query. Accordingly, utterances directed at an assistant-enabled device take the general form [HOTWORD] [QUERY], where “HOTWORD” in this example is “OK computer” and “QUERY” can be any question, command, declaration, or other request that can be speech recognized, parsed and acted on by the system, either alone or in conjunction with the server via the network.

In cases where the user provides several hotword based commands to an assistant-enabled device, such as a mobile phone or smart speaker, the user's interaction with the phone or speaker may become awkward. The user may speak, “Ok computer, play my homework playlist.” The phone or speaker may begin to play the first song on the playlist. The user may wish to advance to the next song and speak, “Ok computer, next.” To advance to yet another song, the user may speak, “Ok computer, next,” again. To alleviate the need to keep repeating the hotword before speaking a command, the assistant-enabled device may be configured to recognize/detect a narrow set of hotphrases or warm words to directly trigger respective actions. In the example, the warm word “next” serves the dual purpose of a hotword and a command so that the user can simply utter “next” to invoke the assistant-enabled device to trigger performance of the respective action instead of uttering “Ok computer, next.”

The assistant-enabled device may include multiple digital assistants that each include a set of warm words active for controlling a long-standing operation. As used herein, a long-standing operation refers to an application or event that a digital assistant performs for an extended duration and one that can be controlled by the user while the application or event is in progress. For instance, when a digital assistant for a clock application sets a timer for 30-minutes, the timer is a long-standing operation from the time of setting the timer until the timer ends or a resulting alert is acknowledged after the timer ends. In this instance, a warm word such as “stop” could be active to allow the user to stop the timer by simply speaking “stop” without first speaking the hotword. Likewise, a command instructing a digital assistant for a music application to play music from a streaming music service is a long-standing operation while the digital assistant is streaming music from the streaming music service through a playback device. In this instance, an active set of warm words can be “stop”, “pause”, “volume up”, “volume down”, “next”, “previous”, etc., for controlling playback of the music the digital assistant is streaming through the playback device. The long-standing operation may include multi-step dialogue queries such as “book a restaurant” in which different sets of warm words will be active depending on a given stage of the multi-step dialogue. For instance, the assistant-enabled device may prompt a user to select from a list of restaurants, whereby a set of warm words may become active that each include a respective identifier (e.g., restaurant name or number in list) for selecting a restaurant from the list and complete the action of booking a reservation for that restaurant.

One challenge with devices that have multiple digital assistants enabled is limiting the number of words/phrases that are simultaneously enabled so that quality and efficiency is not degraded. For instance, a number of false positives indicating when the assistant-enabled device incorrectly detected/recognized one of the active words greatly increases the larger the number of warm words that are simultaneously enabled. Moreover, multiple digital assistants may support the same words/phrases, which creates redundancy and consumes resources that could otherwise be allocated to support additional words/phrases and/or a larger model that can detect words/phrases at a lower false accept rate or false reject rate.

Implementations herein are directed toward enabling a set of one or more warm words associated with a long-standing operation in progress and at least one digital assistant of a multi-assistant enabled device. That is, the warm words that are enabled for detection by the multi-assistant enabled device are associated with a high likelihood of being spoken by the user after the initial command for controlling the long-standing operation, and may also be used to control at least one digital assistant to perform another operation that is different than the long-standing operation in progress. As such, while the assistant-enabled device is performing the long-standing operations commanded by the user, the user may speak any of the enabled warm words to trigger a respective action performed by at least one of the digital assistants for controlling the long-standing operation. A warm word detector and speaker identification may run on the multi-assistant enabled device and consume low power.

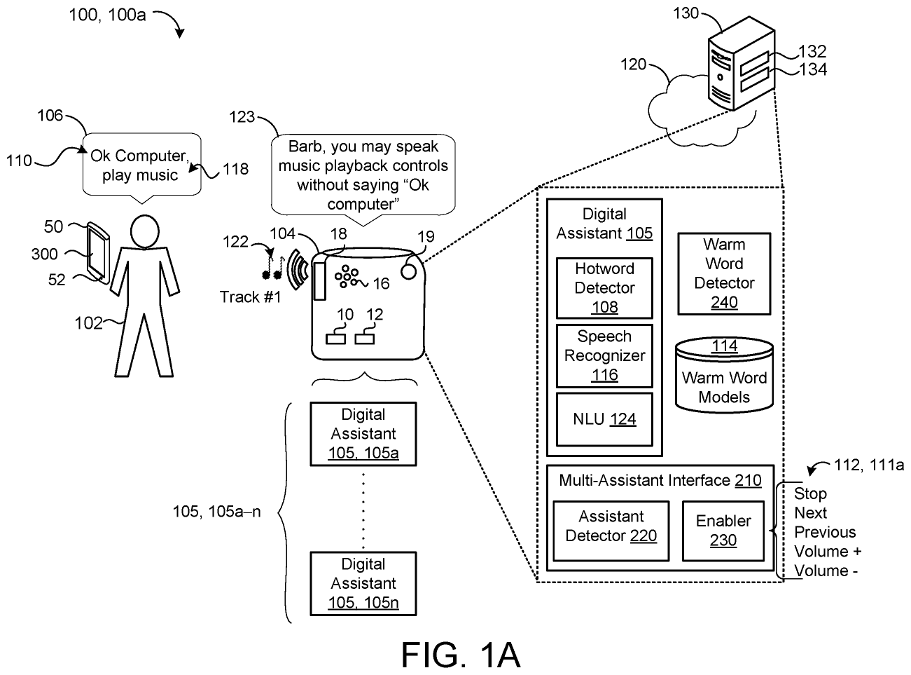

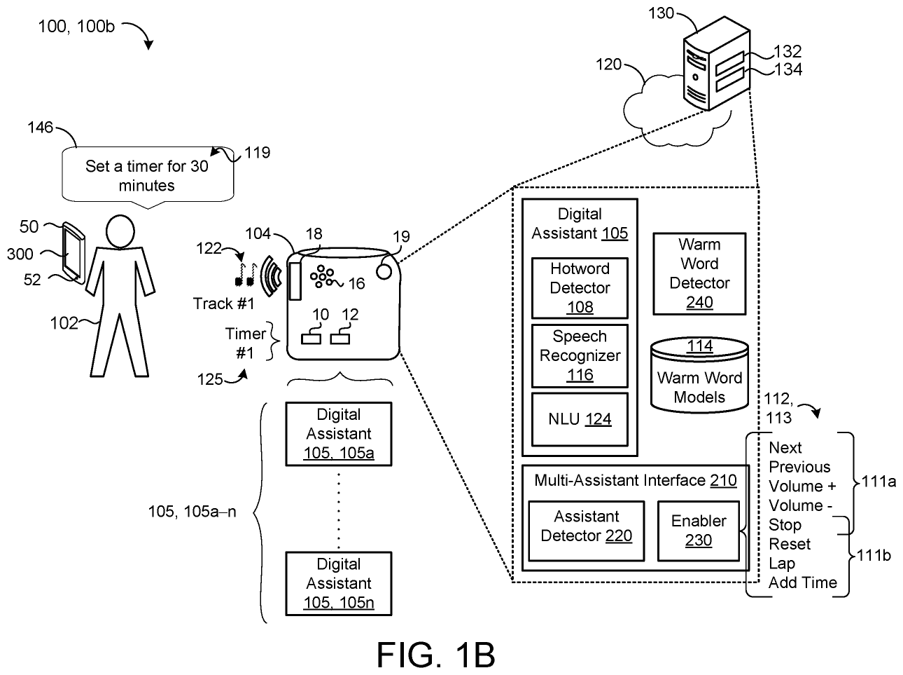

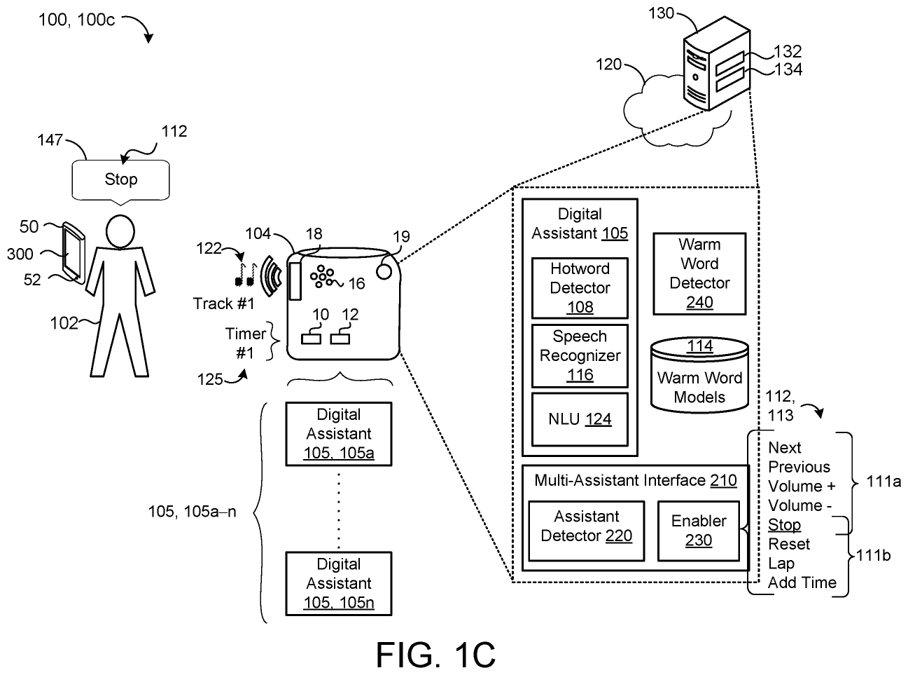

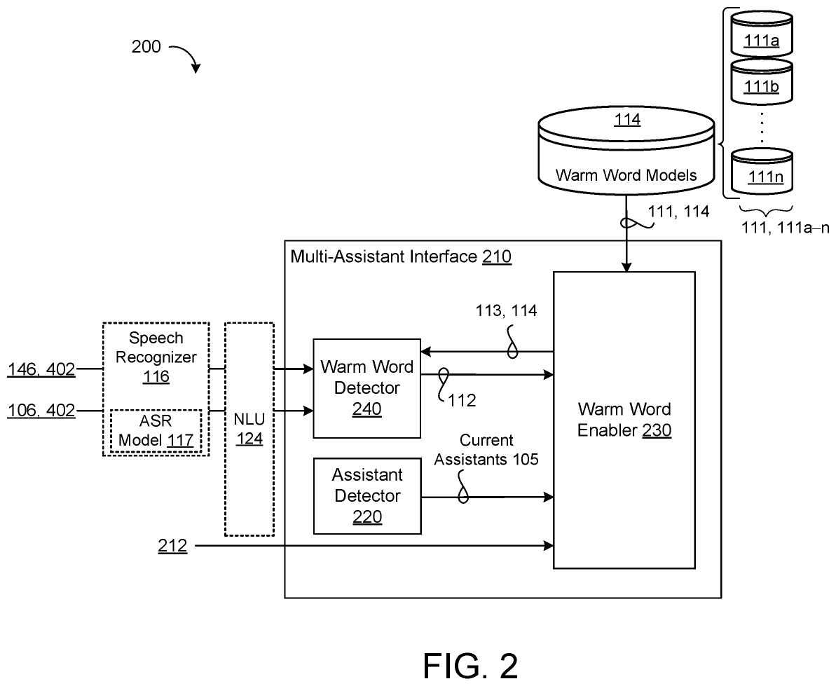

FIGS. 1A-1C illustrate example systems 100, 100a-c for activating warm words 112 for actions for one or more digital assistants 105, 105a-n that control a long-standing operation associated with an initial warm word 112 that a user 102 spoke in an initial command for controlling the long-standing operation. Briefly, and as described in more detail below, a multi-assistant device (MAD) 104 simultaneously executes a group of digital assistants 105, 105a—n. A digital assistant 105 of the MAD 104 begins to play music 122 in response to an utterance 106, “Ok computer, play music,” spoken by the user 102. Additionally, a multi-assistant interface 210 (FIG. 2) of the MAD 104 executes an arbitration routine to enable a final set 113 of warm words 112 for detection by the MAD 104. While the digital assistant 105b is performing the long-standing operation of the music 122 as playback audio from a speaker 18, the MAD 104 is able to detect/recognize an warm word 112 of “stop” (FIG. 1C) that is spoken by the user 102 as an action to control the long-standing operation, e.g., an instruction to stop the playback audio of the music 122. Advantageously, the arbitration routine may identify digital assistants 105 with overlapping warm words, where the MAD 104 only enables a single instance of an overlapping warm word 112, thereby conserving resources of the MAD 104.

The systems 100a-100c include the MAD 104 executing the group of digital assistants 105, 105a-n enabled for simultaneous execution on the MAD 104 that the user 102 may interact with through speech. Each digital assistant 105 of the group of digital assistants 105 may include a respective hotword detector 108, speech recognizer 116, and natural language understanding (NLU) module 124. Additionally or alternatively, the MAD 104 includes an assistant client, which can be a standalone application on top of an operating system or can form all or part of the operating system (e.g., executes a dedicated hotword detector 108, speech recognizer 116, and/or NLU module 124). While the group of digital assistants 105 execute simultaneously on the MAD 104, the digital assistants 105 can all be linked together, or otherwise associated with one another, in one or more data structures. For example, each of the digital assistants 105 may be registered with the same user account, registered with the same set of user accounts, registered with a particular structure, and/or all assigned to a particular structure in a device topology representation. The device topology representation can include, for each of the digital assistants 105, corresponding unique identifiers and can optionally include corresponding unique identifiers for other digital assistants 105 that can be interacted with via a digital assistant. Further, the device topology representation can specify assistant attributes associated with the respective digital assistants 105. The attributes for a given digital assistant 105 can indicate, for example, one or more input and/or output modalities supported by the respective digital assistants 105, processing capabilities for the respective digital assistants 105, a make, model, and/or unique identifier (e.g., serial number) of the respective digital assistants 105 (based on which processing capabilities can be determined), and/or other attributes.

In the example shown, the MAD 104 corresponds to a smart speaker that users 102 may interact with. However, the MAD 104 can include other computing devices, such as, without limitation, a smart phone, tablet, smart display, desktop/laptop, smart watch, smart glasses/headset, smart appliance, headphones, or vehicle infotainment device. The MAD 104 includes data processing hardware 10 and memory hardware 12 storing instructions that when executed on the data processing hardware 10 cause the data processing hardware 10 to perform operations. The MAD 104 includes an array of one or more microphones 16 configured to capture acoustic sounds such as speech directed toward the MAD 104. The MAD 104 may also include, or be in communication with, an audio output device (e.g., speaker) 18 that may output audio such as music 122 and/or synthesized speech from at least one of the digital assistants 105. Additionally, the MAD 104 may include, or be in communication with, one or more cameras 19 configured to capture images within the environment and output image data.

In some configurations, the MAD 104 is in communication with a user device 50 associated with the user 102. In the examples shown, the user device 50 includes a smart phone that the user 102 may interact with. However, the user device 50 can include other computing devices, such as, without limitation, a smart watch, smart display, smart glasses, a smart phone, smart headset, tablet, smart appliance, headphones, a computing device, a smart speaker, or another assistant-enabled device. The user device 50 may include at least one microphone 52 residing on the user device 50 that is in communication with the MAD 104. In these configurations, the user device 50 may also be in communication with the one or more microphones 16 residing on the MAD 104. Additionally, the user 102 may control and/or configure the MAD 104, as well as interact with the digital assistant 105, using an interface 200, such as a graphical user interface (GUI) 300 rendered for display on a screen of the user device 50.

FIG. 1A shows the user 102 speaking an utterance 106, “Ok computer, play music” in the vicinity of the MAD 104. The microphone 16 of the MAD 104 receives the utterance 106 and processes the audio data 402 that corresponds to the utterance 106. The initial processing of the audio data 402 may involve filtering the audio data 402 and converting the audio data 402 from an analog signal to a digital signal. As the MAD 104 processes the audio data 402, the MAD may store the audio data 402 in a buffer of the memory hardware 12 for additional processing. With the audio data 402 in the buffer, the MAD 104 may use a hotword detector 108 (e.g., a hotword detector 108 of one of the digital assistants 105) to detect whether the audio data 402 includes the hotword. The hotword detector 108 is configured to identify hotwords that are included in the audio data 402 without performing speech recognition on the audio data 402.

In some implementations, the hotword detector 108 is configured to identify hotwords that are in the initial portion of the utterance 106. In this example, the hotword detector 108 may determine that the utterance 106 “Ok computer, play music” includes the hotword 110 “ok computer” if the hotword detector 108 detects acoustic features in the audio data 402 that are characteristic of the hotword 110. The acoustic features may be mel-frequency cepstral coefficients (MFCCs) that are representations of short-term power spectrums of the utterance 106 or may be mel-scale filterbank energies for the utterance 106. For example, the hotword detector 108 may detect that the utterance 106 “Ok computer, play music” includes the hotword 110 “ok computer” based on generating MFCCs from the audio data 402 and classifying that the MFCCs include MFCCs that are similar to MFCCs that are characteristic of the hotword “ok computer” as stored in a hotword model of the hotword detector 108. As another example, the hotword detector 108 may detect that the utterance 106 “Ok computer, play music” includes the hotword 110 “ok computer” based on generating mel-scale filterbank energies from the audio data 402 and classifying that the mel-scale filterbank energies include mel-scale filterbank energies that are similar to mel-scale filterbank energies that are characteristic of the hotword “ok computer” as stored in the hotword model of the hotword detector 108.

When the hotword detector 108 determines that the audio data 402 that corresponds to the utterance 106 includes the hotword 110, the MAD 104 may trigger a wake-up process to initiate speech recognition on the audio data 402 that corresponds to the utterance 106. For example, FIG. 2 shows the MAD 105 including a speech recognizer 116 (e.g., a speech recognizer 116 of one of the digital assistants 105) employing an automatic speech recognition model 117 that may perform speech recognition or semantic interpretation on the audio data 402 that corresponds to the utterance 106. The speech recognizer 116 may perform speech recognition on the portion of the audio data 402 that follows the hotword 110. In this example, the speech recognizer 116 may identify the words “play music” in the command 118.

In some examples, the MAD 104 is configured to communicate with a remote system 130 via a network 120. The remote system 130 may include remote resources, such as remote data processing hardware 132 (e.g., remote servers or CPUs) and/or remote memory hardware 134 (e.g., remote databases or other storage hardware). The MAD 104 may utilize the remote resources to perform various functionality related to speech processing and/or synthesized playback communication. In some implementations, the speech recognizer 116 is located on the remote system 130 in addition to, or in lieu, of the MAD 104. Upon the hotword detector 108 triggering the MAD 104 to wake-up responsive to detecting the hotword 110 in utterance 106, the MAD 104 may transmit the initial audio data 402 corresponding to the utterance 106 to the remote system 130 via the network 120. Here, the MAD 104 may transmit the portion of the initial audio data 402 that includes the hotword 110 for the remote system 130 to confirm the presence of the hotword 110. Alternatively, the MAD 104 may transmit only the portion of the initial audio data 402 that corresponds to the portion of the utterance 106 after the hotword 110 to the remote system 130, where the remote system 130 executes the speech recognizer 116 to perform speech recognition and returns a transcription of the initial audio data 402 to the MAD 104.

With continued reference to FIGS. 1A-2, the MAD 104 may further include an NLU module 124 (e.g., an NLU module 124 of one of the digital assistants 105) that performs semantic interpretation on the utterance 106 to identify the query/command directed toward the MAD 104. Specifically, the NLU module 124 identifies the words in the utterance 106 identified by the speech recognizer 116, and performs semantic interpretation to identify any speech commands in the utterance 106. The NLU module 124 of the MAD 104 (and/or the remote system 130) may identify the words “play music” as a command specifying a long-standing operation (i.e., play music 122) for the digital assistant 105. In the example shown, a digital assistant 105 executing on the MAD 104 begins to perform the long-standing operation of playing music 122 as playback audio (e.g., Track #1) from the speaker 18 of the MAD 104. The digital assistant 105 may stream the music 122 from a streaming service (not shown) or the digital assistant 105 may instruct the MAD 104 to play music stored on the MAD 104. While the example long-standing operation includes music playback, the long-standing operation may include other types of media playback, such as video, podcasts, and/or audio books. The long-standing operation may also include home automation (e.g, adjusting light levels, controlling a thermostat, etc.).

Still referring to FIGS. 1A-2, the MAD 104 (and/or the server 130) may include a multi-assistant interface 210 executing an assistant detector 220, a warm word enabler 230, and a warm word detector 240. The assistant detector 220 may be configured to discover one or more enabled digital assistants 105 executing simultaneously on the MAD 104. Based on changes in one of the group of assistant devices 105 discovered by the assistant detector 220, warm words 112 detected by the warm word detector 240, and/or context 212 in the environment of the user and/or the user device 50, the warm word enabler 230 is triggered to execute a warm word arbitration routine that determines which warm words 112 to include in the final set 113 of warm words 112 based on processing constraints of the MAD 104. The warm word detector 240 receives the final set 113 of warm words 112 and, as described in more detail below, may detect a warm word 112 from the final set 113 in streaming audio captured by the MAD 104 without performing speech recognition on the captured audio.

The MAD 104 may notify the user 102 (e.g., Barb) that spoke the utterance 106 that the long-standing operation is being performed. For instance, the digital assistant 105 may generate synthesized speech 123 (FIG. 1A) for audible output from the speaker 18 of the MAD 104 that states, “Barb, you may speak music playback controls without saying ‘Ok Computer’”. In additional examples, the digital assistant 105 provides a notification to the user device 50 associated with the user 102 (e.g., Barb) to inform the user 102 which warm words 112 are currently enabled for controlling the long-standing operation.

With reference to FIG. 2, during execution of the digital assistant 105, the MAD 104 discovers digital assistants 105 for the group of digital assistants 105 enabled for simultaneous execution on the MAD 104 using the assistant detector 220. For example, the one or more enabled digital assistants 105 may be discovered based on which long-standing operations the MAD 104 is currently performing. In other examples, the one or more enabled digital assistants 105 are added to the group of digital assistants 105 when the MAD 104 receives a user command specifying a long-standing operation for a corresponding digital assistant 105 to perform. The user command specifying a long-standing operation may include a user input indication via any one or of touch, speech, gesture, gaze, and/or an input device (e.g., mouse or stylus) for interacting with the MAD 104. Additionally, or alternatively, the user command specifying a long-standing operation for a corresponding digital assistant 105 may trigger discovery of one or more additional digital assistants 105 that interface/interact with the corresponding digital assistant 105. In other examples, the assistant detector 220 monitors the activity of the applications executing on the MAD 104 to identify active applications that include corresponding digital assistants 105.

In some implementations, the assistant detector 220 maintains a list of previous digital assistants 105 in the group of digital assistants 105 enabled for simultaneous execution on the MAD 104. Here, the list of previous digital assistants 105 may refer to a list of the digital assistants 105 discovered by the assistant detector 220 that is not the most recent (i.e., most current) detection of assistant devices 105. In this example, after discovering the one or more digital assistants 105 in the group of digital assistants 105, the assistant detector 220 may determine that the list of previous digital assistants 105 does not include the same digital assistants 105 associated with a current state of the MAD 104. In other words, the assistant detector 220 may determine that the digital assistants 105 in the list of previous digital assistants 105 is different than the digital assistants 105 currently executing on the MAD 104. This change between the list of previous digital assistants 105 and the list of current digital assistants 105 triggers the enabler 230 to execute the warm word arbitration routine to add or remove warm words 112 from the final set 113 of warm words 112 enabled for detection by the MAD 104 based on the current digital assistants 105. For example, if a new digital assistant 105 starts execution on the MAD 104, the assistant detector 220 may discover that the new digital assistant 105 in the group of digital assistants 105 is enabled for simultaneous execution on the MAD 105 by comparing the list of current digital assistants 105 including the digital assistant 105 against the previous list of the digital assistants 105 that does not include the digital assistant 105. In response, the warm word enabler 230 triggers execution of the warm word arbitration routine to add/update any warm words 112 in the final set 113 of warm words 112. Conversely, if a digital assistant 105 ceases execution on the MAD 104, the assistant detector 220 may discover that the digital assistant 105 has been removed from the group of digital assistants 105 by comparing the list of previous digital assistants 105 including the digital assistant 105 against the list of current digital assistants 105 that does not include the digital assistant 105. In response, the warm word enabler 230 triggers execution of the warm word arbitration routine to add/update any warm words 112 in the final set 113 of warm words 112. In some examples, however, when the assistant detector 220 determines that the list of previous digital assistants 105 is the same as the list of the current digital assistants 105, the assistant detector 220 may not send the list of the current digital assistants 105 to update the final set 113 of warm words 112.

In some implementations, the MAD 104 identifies warm words 112 that are added or removed from a respective active set 111 of warm words 112 for one or more of the digital assistants 105 in the group of digital assistants 105. For example, the user 102 may speak “pause” to pause the playback of music 122. While the music is paused, the MAD 104 may determine that the warm word 122 “pause” is removed from the respective active set 111 of warm words 112 associated with the digital assistant 105 controlling music playback since the user 102 is not likely to speak this warm word. In other words, once the user speaks “pause” the digital assistant 105 may designate the warm word 112 “pause” as an inactive warm word 112, as the user 102 is unlikely to repeat the warm word 112 “pause”. In response to determining that the warm word 112 “pause” is removed from the active set 111 of warm words 112, the MAD 104 (via the warm word enabler 230) executes the warm word arbitration routine to update the final set 113 of warm words 112. Continuing with the example, the MAD 104 may determine that the warm word 112 “play” is added to the active set 111 of warm words 112 in response to the user 102 speaking “pause”, as a user 102 is likely to restart playback of the music 122 within a threshold amount of time. In response to determining that the warm word 112 “play” is added to the active set 111 of warm words 112, the MAD executes the warm word arbitration routine to update the final set 113 of warm words 112. In other implementations, the warm word arbitration routine is triggered based on an addition of a warm word 112 or a removal of a warm word 112 in the respective active set 111 of warm words 112 for a corresponding digital assistant 105 (e.g., based on a user-requested configuration change).

In some implementations, the warm word enabler 230 executes the warm word arbitration routine in response to determining a change in ambient context 212. For example, ambient context 212 may include background noise in the environment of the user 102, where an increase in volume may constitute a change in ambient context 212 that triggers the warm word arbitration routine to update/modify the final set 113 of warm words 112 to include a more capable warm word model 114 for one or more of the enabled warm words 112 that more accurately detect warm words 112 in a noisy environment. In other examples, ambient context 212 may include lighting in the environment of the MAD 104. Here, the camera 19 of the MAD 104 may capture image data that indicates the lights are lower (e.g., the user 102 is starting a routine for bed) as a change in ambient context 212 that triggers the warm word arbitration routine to enable warm words 112 for controlling an alarm clock digital assistant 105. Similarly, the change in ambient context 212 may include various times of the day, where the warm word arbitration routine is triggered to enable/disable warm words 112 based on the time of day. In these examples, the MAD 104 may automatically execute the warm word arbitration routine to update the enabled warm words 112 based on a routine of the user 102 of the MAD 104 that corresponds to discrete times of the day. In even further examples, the ambient context 218 may include a proximity to other assistant-enabled devices. For example, when the MAD 104 is a vehicle system, the user 102 may instruct a vehicle digital assistant 105 to turn on the climate control where the vehicle entering a threshold proximity to another assistant-enabled device (e.g., a smart thermostat in the home of the user 102) causes a change in ambient context 218 that triggers the MAD 104 to execute the warm word arbitration routine (e.g., update the final set 113 to include warm words 112 corresponding to the smart thermostat).

With continued reference to FIG. 2, for each enabled digital assistant 105 in the group of enabled digital assistants 105 that is discovered by the assistant detector 220, the warm word enabler 230 may receive a respective active set 111, 111a—n of warm words 112 that each specify a respective action for the respective digital assistant 105 to perform. In other words, receiving the respective active set 111 of warm words 112 associated with the digital assistant 105 includes receiving, in response to the corresponding digital assistant 105 performing the long-standing operation, the respective active set 111 of warm words 112 associated with the corresponding digital assistant 105. Based on the respective active set 111 of warm words 112 associated with each digital assistant 105 in the group of digital assistants 105, the warm word enabler 230 executes a warm word arbitration routine to enable a final set 113 of warm words 112 for detection by the MAD 104. The final set 113 of warm words 112 may include warm words selected from the respective active set 111 of warm words 112 associated with one or more of the digital assistants 105 in the group of digital assistants 105.

In some implementations, for each warm word 112 in the active set 111 of warm words 112, the multi-assistant user interface 210 additionally receives a respective warm word model 114 configured to detect the corresponding warm word 112 in streaming audio without performing speech recognition. For example, the MAD 104 (and/or the server 130) additionally includes one or more warm word models 114. Here, the warm word models 114 may be stored on the memory hardware 12 of the MAD 104 or the remote memory hardware 134 on the server 130. If stored on the server 130, the MAD 104 may request the server 130 to retrieve a warm word model 114 for a corresponding warm word 112 and provide the retrieved warm word model 114 so that the MAD 104 (via the warm word enabler 230) can enable the warm word model 114. An enabled warm word model 114 running on the warm word detector 240 of the MAD 104 may detect an utterance of the corresponding warm word 112 in streaming audio captured by the MAD 104 without performing speech recognition on the captured audio. Further, a single warm word model 114 may be capable of detecting all of the warm words 112 in streaming audio. Thus, a warm word model 114 may detect one or more warm words 112, and a different warm word model 114 may detect one or more other warm words 112.

In some configurations, the warm word enabler 230 receives code associated with an application of the long-standing operation (e.g., a music application running in the foreground or background of the MAD 104) to identify any warm words 112 and associated warm word models 114 that developers of the application want users 102 to be able to speak to interact with the application and the respective actions for each warm word 112. In other examples, the warm word enabler 230 receives, for at least one warm word 112 in the respective active set 111 of warm words 112 via a warm word application programming interface (API) executing on the MAD 104, a respective warm word model 114 configured to detect the corresponding warm word 112 in streaming audio without performing speech recognition. The warm words 112 in the registry may also relate to follow-up queries that the user 102 (or typical users) tend to issue following the given query, e.g., “Ok computer, next track”.

In additional implementations, enabling the final set 113 of warm words 112 by the warm word enabler 230 causes the MAD 104 to execute the speech recognizer 116 in a low-power and low-fidelity state. Here, the speech recognizer 116 is constrained or biased to only recognize the one or more warm words 112 that are enabled when spoken in the utterance captured by the MAD 104. Since the speech recognizer 116 is only recognizing a limited number of terms/phrases, the number of parameters of the speech recognizer 116 may be drastically reduced, thereby reducing the memory requirements and number of computations needed for recognizing the warm words in speech. Accordingly, the low-power and low-fidelity characteristics of the speech recognizer 116 may be suitable for execution on a digital signal processor (DSP). In these implementations, the speech recognizer 116 executing on the MAD 104 may recognize an utterance 147 of an enabled warm word 112 in streaming audio captured by the MAD 104 in lieu of using a warm word model 114.

As described above, the warm word enabler 230 executes the warm word arbitration routine to identify, based on resource constraints of the MAD 104, which warm words 112 can be enabled, what quality of warm word models 114 are used, and/or what tolerance for errors the MAD 104 is appropriate. For example, the warm word arbitration routine may assign highest priority to warm words 112 that are shared across multiple digital assistants 105 in the group of digital assistants 105, where the remaining warm words 112 are ranked based on metadata and/or historical usage of the warm words 112. For example, the warm word enabler 230 identifies any shared warm words 112 corresponding to warm words 112 present in at least two active sets 111 of warm words 112, where the warm word arbitration routine assigns a higher priority for enabling warm words 112 identified as shared warm words 112. Additionally or alternatively, the warm word arbitration routine assigns high priority to warm words 112 that are similar. Here, warm words 112 that are similar-sounding and are associated with the same intent may be merged into a single warm word model 114. Alternatively, warm words 112 that are similar-sounding and are associated with different intents may have distinct warm word models 114 to limit errors in detection of the warm word 112.

In some implementations, for each warm word 112 in the active set 111 of warm words 112 for each of the digital assistants 105, a priority score for the warm word 112 may be determined based on features of the corresponding digital assistant 105. The priority score may also be determined based on user features and/or warm word embeddings. The priority score may be determined taking into account warm words that may be related semantically (e.g., “play” and “pause”) and/or phonetically similar and that might be more relevant for a particular digital assistant 105, e.g., based on a user's preferred digital assistant 105. In some implementations, the priority score may be determined based on output of a machine learning model.

In some examples, the warm word arbitration routine executed by the warm word enabler 230 of the multi-assistant interface 210 may obtain enabled warm word constraints when determining the final set 113 of warm words 112 to enable for detection by the MAD 104. Here, a number of the warm words 112 in the final set 113 of warm words 112 enabled for detection by the MAD 104 is based on the obtained enabled warm word constraints. For example, the enabled warm word constraints may include the memory hardware 12 and data processing hardware 10 resource availability on the MAD 104 for detecting warm words 112, or the computational requirements for enabling each warm word 112 in the respective active set 111 of warm words 112 associated with each respective digital assistant 105 in the group of digital assistants. Additionally or alternatively, the enabled warm word constraints include an acceptable false acceptance rate tolerance or an acceptable false reject rate tolerance. In these examples, the enabled warm word constraints define the boundaries within which the warm word arbitration routine must operate for enabling the final set 113 of warm words 112.

The warm word enabler 230 may maintain a log of an identity and/or timestamp of when each of the warm words 112 are detected by the warm word detector 240 to generate additional parameters for the warm word arbitration routine. For example, the warm word enabler 230 may determine a frequency of detection of a warm word 112 by the MAD 104 when executing the warm word arbitration routine. In these examples, the warm word enabler 230 may determine the frequency of detection of each warm word 112 in the respective active set 111 of warm words 112 for each respective digital assistant 105 in the group of digital assistants 105, where the final set 113 of warm words 112 is based on the determined frequency of detection. Here, the determined frequency of detection defines, for each digital assistant 105, an affinity for the warm word 112. In other words, each digital assistant 105 may have a different affinity for each warm word 112 based on a frequency of detection of the warm word 112 by the respective digital assistant 105. Likewise, the warm word arbitration routine may include, for each warm word 112 in the respective active set 111 of warm words 112 for each respective digital assistant 105, a time when the warm word 112 was most recently detected by the MAD 104. Here, determining the final set 113 of warm words 112 is based on the determined time that each warm word 112 in the respective active set 111 of warm words 112 for each respective digital assistant 105 was most recently detected. In these examples, warm words 112 most recently detected may be assigned a higher priority during the warm worm arbitration routine than warm words 112 that were not detected recently and/or are infrequently detected.

Referring again to FIG. 1A, for the long-standing operation of playing music 122, the assistant detector 220 detects/determines that a digital assistant 105 for a music application is active. The warm word enabler 230 receives the respective active set 111a of warm words 112 to control the long-standing operation of playing music, where the active set 111a includes the warm words 112 “stop”, “next”, “previous”, “volume up”, and “volume down” each associated with the respective action for controlling playback of the music 122 from the speaker 18 of the MAD 104. Based on receiving the active set 111a of warm words 112, the warm word enabler executes the warm word arbitration routine and enables the warm words 112 “stop”, “next”, “previous”, “volume up”, and “volume down”, while the digital assistant 105 is performing the long-standing operation and may deactivate these warm words 112 once the long-standing operation ends.

In the example shown in FIG. 1B, while the digital assistant 105 executing on the MAD 104 is performing the long-standing operation of playing music 122, the MAD 104 receives an utterance 146 “Set a timer for 30 minutes,” spoken by the user 102. Here, operating the timer 125 is a long-standing operation from the time of setting the timer until the timer ends or a resulting alert is acknowledged after the timer ends. Based on the long-standing operation of operating the timer 125, the assistant detector 220 detects/determines that a digital assistant 105 for a clock application is active, thereby resulting in a change of the current assistants 105 (i.e., triggering the warm word enabler 230 to execute the warm word arbitration routine). In response, the warm word enabler 230 receives the respective active set 111b of warm words 112 that each specify a respective action for the digital assistant (e.g., a clock digital assistant) to perform. In this instance, for the long-standing operation of operating the timer 125, the respective active set 111b of warm words 112 received by the warm word enabler 230 includes the warm words 112 “reset”, “lap”, “stop”, and “add time” each associated with the respective action for controlling the operation of operating the timer 125 on the MAD 104.

Based on the received active set 111b of warm words 112 and the received active set 111a of warm words 112, the warm word enabler 230 executes the warm word arbitration routine to enable the final set 113 of warm words 112 for detection by the MAD 104 by selecting warm words 112 from the respective active sets 111a, 111b of warm words 112. Here, the warm word arbitration routine identifies that the active set 111a and the active set 111b each include the warm word 112 “stop”. Rather than enable detection for two separate warm word models 114 for the warm word 112 “stop”, the warm word arbitration routine selects only one warm word model 114 for the warm word 112 “stop”. In some implementations, the warm word arbitration routine determines that the MAD 104 has sufficient capacity and enables execution of a higher quality (i.e., additional parameters, decreased latency, and/or increased sensitivity) warm word model 114 for the warm word 112 “stop”. As shown in the example, the multi-assistant interface 210 enables the final set 113 of warm words 112 that includes the warm words 112 “next”, “previous”, “volume up”, “volume down”, “stop”, “reset”, “lap”, and “add time”.

Referring to FIG. 1C, while the MAD 104 is performing the long-standing operation of playing music 122, and the long-standing operation of operating a timer 125, the user 102 speaks an utterance 147 that includes a warm word 112 from the final set 113 of warm words 112 enabled for detection by the MAD 104. In the example shown, the user 102 utters the enabled warm word 112 “stop”. Without performing speech recognition on the captured audio, the MAD 104 may apply the warm word models 114 for the final set 113 of warm words 112 to identify whether the utterance 147 includes any warm words 112 in the final set 113. The final set 113 of warm words 112 may be “next”, “previous”, “volume up”, “volume down”, “stop”, “reset”, “lap”, and “add time”. The MAD 104 compares the audio data 402 that corresponds to the utterance 147 to the enabled warm word models 114 that correspond to the enabled warm words 112 “next”, “previous”, “volume up”, “volume down”, “stop”, “reset”, “lap”, and “add time” and determines that the warm word model 114 enabled for the warm word 112 “stop” detects the warm word 112 “stop” in the utterance 147 without performing speech recognition on the audio data 402.

Because the MAD 104 detects, in the audio data 402, the shared warm word 112 “stop”, the MAD 104 may perform query interpretation using the NLU module 124 to obtain additional context of the MAD 104 to determine which long-standing operation (and corresponding digital assistant 105) that the user 102 is referring to. For example, the NLU module 124 may determine, based on context that the timer is running, that it is more likely that the user 102 wants to stop the long standing operation of operating the timer 125 than to stop the long standing operation of playing music 122. Alternatively, the context may indicate that the user 102 has moved from a room away from the MAD 104, where the NLU module 120 may determine that it is more likely that the user 102 wants to stop the music 122 because the user 102 is no longer in proximity to the MAD 104. Put differently, downstream actions for controlling the long standing operations may rely on context determined by the NLU module 124 when determining which action to perform for a shared warm word 112 that is active for performing actions by multiple digital assistants 105.

In some implementations, the user 102 issues a voice command spoken in the vicinity of the MAD 104 and captured by the MAD 104 in streaming audio. Here, the voice command spoken by the user 102 commands the MAD 104 to enable a first digital assistant 105 and a second digital assistant 105 to execute simultaneously on the MAD 104. In these implementations, the MAD 104 may include an assistant client (e.g., a standalone application on top of an operating system), where the first digital assistant 105 includes the assistant client already executing on the MAD 104, which activates a second digital assistant 105 in response to receiving the voice command. In other words, after receiving the voice command, the first digital assistant 105 and the second digital assistant 105 are enabled to execute simultaneously with one another on the MAD 104. Here, the group of digital assistants 105 includes the first digital assistant 105 and the second digital assistant 105.

In other implementations, the MAD 104 receives, from a software application executing on the MAD 104 or another assistant device (e.g., the user device 50) in communication with the MAD 104, a multi-assistant configuration request to enable a first digital assistant 105 and a second digital assistant 105 to execute simultaneously on the MAD 104. In these implementations, the software application may correspond to an assistant client as a standalone operation on top of an operating system, where the user 102 may configure the MAD 104 to execute the first digital assistant 105 and the second digital assistant 105 to execute simultaneously. For example, a user device 50 executing the software application may submit a request to the MAD 104 to simultaneously execute the first digital assistant 105 and the second digital assistant 105. In other examples, a home automation software application executing on the MAD 104 is configured to include a first digital assistant 105 (e.g., a browser digital assistant 105) and a second digital assistant 105 (e.g., a music digital assistant 105). In these implementations, after receiving the multi-assistant configuration request, the MAD 104 enables the first digital assistant 105 and the second digital assistant 105 to execute simultaneously with one another, where the group of digital assistants 105 includes the first digital assistant 105 and the second digital assistant 105.

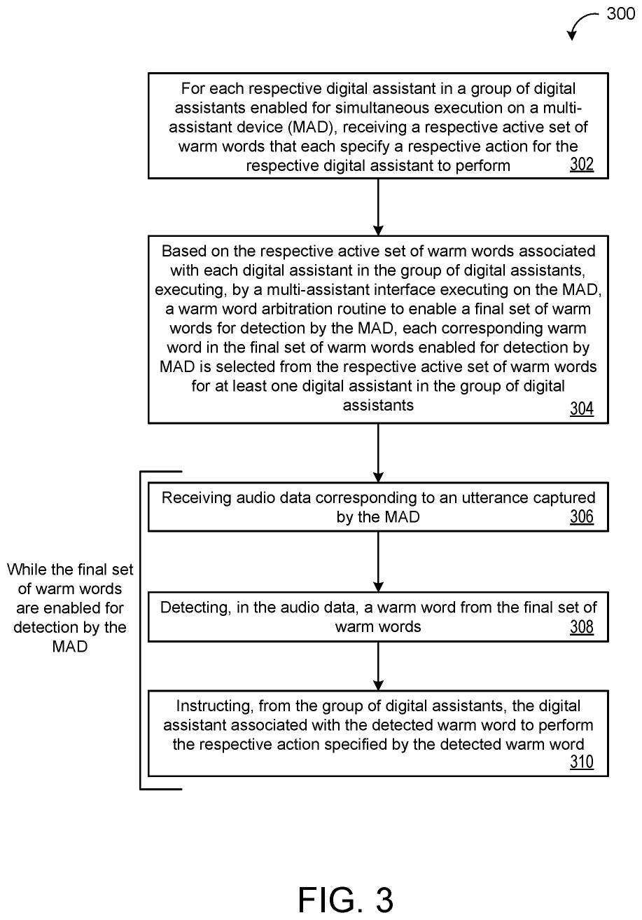

FIG. 3 is a flowchart of an example arrangement of operations for a method 300 for detecting warm words for multiple digital assistants. At operation 302, for each respective digital assistant 105 in a group of digital assistants 105, 105a-n enabled for simultaneous execution on a multi-assistant device (MAD) 104, the method 300 includes receiving a respective active set 111, 111a—n of warm words 112 that each specify a respective action for the respective digital assistant 105 to perform. At operation 304, based on the respective active set 111 of warm words 112 associated with each digital assistant 105 in the group of digital assistants 105, the method 300 also includes executing, by a multi-assistant interface 210 executing on the MAD 104, a warm word arbitration routine to enable a final set 113 of warm words 114 for detection by the MAD 104. Each corresponding warm word 112 in the final set 113 of warm words 112 that is enabled for detection by MAD 104 is selected from the respective active set 111 of warm words 112 for at least one digital assistant 105 in the group of digital assistants 105.

While the final set 113 of warm words 112 are enabled for detection by the MAD 104, the method 300 includes, at operation 306, receiving audio data 402 corresponding to an utterance 146 captured by the MAD 104. At operation 308, the method 300 also includes detecting, in the audio data 402, a warm word 112 from the final set 113 of warm words 112. The method 300 also includes, at operation 310, instructing, from the group of digital assistants 105, the digital assistant 105 associated with the detected warm word 112 to perform the respective action specified by the detected warm word 112.

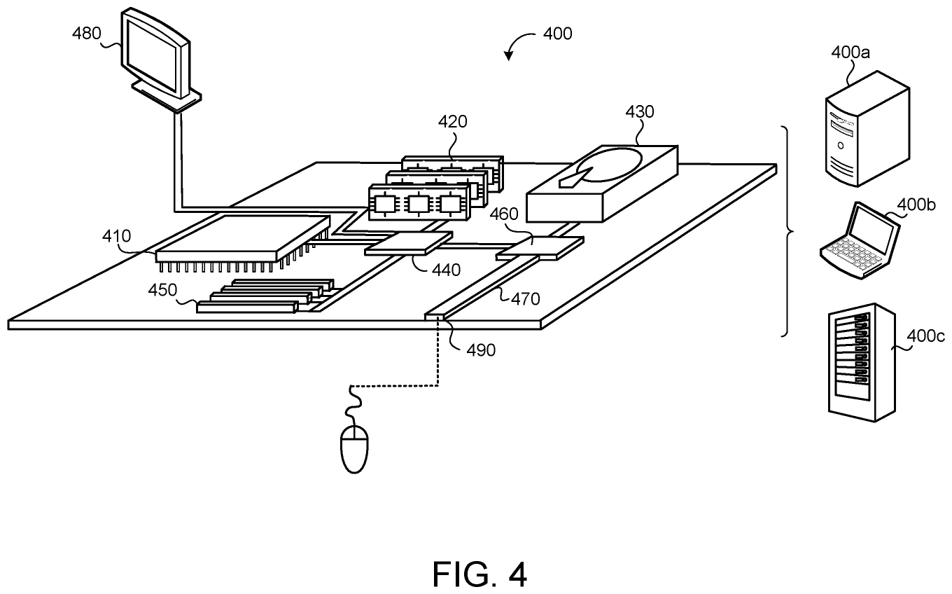

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 (e.g., data processing hardware 12 and/or remote data processing hardware 132 of FIG. 1A) can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 (e.g., memory hardware 12 and/or remote memory hardware 134 of FIG. 1A) stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
for each respective digital assistant in a group of digital assistants enabled for simultaneous execution on a multi-assistant device (MAD), receiving a respective active set of warm words that each specify a respective action for the respective digital assistant to perform;
based on the respective active set of warm words associated with each digital assistant in the group of digital assistants, executing, by a multi-assistant interface executing on the MAD, a warm word arbitration routine to enable a final set of warm words for detection by the MAD, each corresponding warm word in the final set of warm words enabled for detection by the MAD is selected from the respective active set of warm words for at least one digital assistant in the group of digital assistants; and
while the final set of warm words are enabled for detection by the MAD:
receiving audio data corresponding to an utterance captured by the MAD;
detecting, in the audio data, a warm word from the final set of warm words; and
instructing, from the group of digital assistants, the digital assistant associated with the detected warm word to perform the respective action specified by the detected warm word.

2. The computer-implemented method of claim 1, wherein receiving the respective active set of warm words associated with the digital assistant comprises receiving, for at least one warm word in the respective active set of warm words, via a warm word application programming interface (API) executing on the MAD, a respective warm word model configured to detect the corresponding warm word in streaming audio without performing speech recognition.

3. The computer-implemented method of claim 1, wherein the operations further comprise, for a corresponding one of the digital assistants in the group of digital assistants:
receiving a user command specifying a long-standing operation for the corresponding digital assistant to perform;
performing, via the corresponding digital assistant, the long-standing operation specified by the user command,
wherein receiving the respective active set of warm words associated with the digital assistant comprises receiving, in response to the corresponding digital assistant performing the long-standing operation, the respective active set of warm words associated with the corresponding digital assistant.

4. The computer-implemented method of claim 3, wherein each warm word in the respective active set of warm words is associated with a respective action for controlling the long-standing operation performed by the corresponding digital assistant.

5. The computer-implemented method of claim 1, wherein the operations further comprise:
discovering a new digital assistant in the group of digital assistants enabled for simultaneous execution on the MAD,
wherein the multi-assistant interface executes the warm word arbitration routine in response to discovering the new digital assistant in the group of digital assistants.

6. The computer-implemented method of claim 1, wherein the operations further comprise:
determining that a digital assistant has been removed from the group of digital assistants enabled for simultaneous execution on the MAD,
wherein the multi-assistant interface executes the warm word arbitration routine in response to determining that the digital assistant has been removed from the group of digital assistants.

7. The computer-implemented method of claim 1, wherein the operations further comprise, for a corresponding one of the digital assistants in the group of digital assistants:
determining an addition of a warm word or a removal of a warm word in the respective active set of warm words associated with the corresponding digital assistant,
wherein the multi-assistant interface executes the warm word arbitration routine in response to determining the addition of the warm word or the removal of the warm word in the respective set of warm words.

8. The computer-implemented method of claim 1, wherein the operations further comprise:
determining a change in ambient context,
wherein the multi-assistant interface executes the warm word arbitration routine in response to determining the change in ambient context.

9. The computer-implemented method of claim 1, wherein the operations further comprise:
obtaining enabled warm word constraints, the enabled warm word constraints comprising at least one of:
memory and computing resource availability on the MAD for detection of warm words;
computational requirements for enabling each warm word in respective active set of warm words associated with each respective digital assistant in the group of digital assistants;
an acceptable false accept rate tolerance; or
an acceptable false reject rate tolerance,
wherein a number of the warm words in the final set of warm words enabled for detection by the MAD is based on the obtained enabled warm word constraints.

10. The computer-implemented method of claim 1, wherein executing the warm word arbitration routine comprises:
identifying any shared warm words corresponding to warm words present in at least two of the active sets of warm words; and
determining the final set of warm words is based on assigning a higher priority to warm words identified as shared warm words.

11. The computer-implemented of claim 1, wherein executing the warm word arbitration routine comprises:
for each warm word in the respective active set of warm words for each respective digital assistant in the group of digital assistants, determining a frequency of detection of the warm word by the MAD; and
determining the final set of warm words is based on the determined frequency of detection of each warm word in the respective active set of warm words for each respective digital assistant in the group of digital assistants.

12. The computer-implemented method of claim 1, wherein executing the warm word arbitration routine comprises:
for each warm word in the respective active set of warm words for each respective digital assistant in the group of digital assistants, determining a time when the warm word was most recently detected by the MAD; and
determining the final set of warm words is based on the determined time that each warm word in the respective active set of warm words for each respective digital assistant in the group of digital assistants was most recently detected.

13. The computer-implemented method of claim 1, wherein the operations further comprise:
receiving a voice command that commands the MAD to enable a first digital assistant and a second digital assistant to execute simultaneously on the MAD, the voice command spoken by a user of the MAD and captured by the MAD in streaming audio; and
after receiving the voice command, enabling the first digital assistant and the second digital assistant to execute simultaneously with one another on the MAD, wherein the group of digital assistants comprises the first digital assistant and the second digital assistant.

14. The computer-implemented method of claim 1, wherein the operations further comprise:
receiving, from a software application executing on the MAD or another device in communication with the MAD, a multi-assistant configuration request to enable a first digital assistant and a second digital assistant to execute simultaneously on the MAD; and
after receiving the multi-assistant configuration request, enabling the first digital assistant and the second digital assistant to execute simultaneously with one another on the MAD, wherein the group of digital assistants comprises the first digital assistant and the second digital assistant.

15. A system comprising:
data processing hardware; and
memory hardware in communication with the data processing hardware, the memory hardware storing instructions that when executed on the data processing hardware cause the data processing hardware to perform operations comprising:
for each respective digital assistant in a group of digital assistants enabled for simultaneous execution on a multi-assistant device (MAD), receiving a respective active set of warm words that each specify a respective action for the respective digital assistant to perform;
based on the respective active set of warm words associated with each digital assistant in the group of digital assistants, executing, by a multi-assistant interface executing on the MAD, a warm word arbitration routine to enable a final set of warm words for detection by the MAD, each corresponding warm word in the final set of warm words enabled for detection by the MAD is selected from the respective active set of warm words for at least one digital assistant in the group of digital assistants; and
while the final set of warm words are enabled for detection by the MAD:
receiving audio data corresponding to an utterance captured by the MAD;
detecting, in the audio data, a warm word from the final set of warm words; and
instructing, from the group of digital assistants, the digital assistant associated with the detected warm word to perform the respective action specified by the detected warm word.

16. The system of claim 15, wherein receiving the respective active set of warm words associated with the digital assistant comprises receiving, for at least one warm word in the respective active set of warm words, via a warm word application programming interface (API) executing on the MAD, a respective warm word model configured to detect the corresponding warm word in streaming audio without performing speech recognition.

17. The system of claim 15, wherein the operations further comprise, for a corresponding one of the digital assistants in the group of digital assistants:
receiving a user command specifying a long-standing operation for the corresponding digital assistant to perform;
performing, via the corresponding digital assistant, the long-standing operation specified by the user command,
wherein receiving the respective active set of warm words associated with the digital assistant comprises receiving, in response to the corresponding digital assistant performing the long-standing operation, the respective active set of warm words associated with the corresponding digital assistant.

18. The system of claim 17, wherein each warm word in the respective active set of warm words is associated with a respective action for controlling the long-standing operation performed by the corresponding digital assistant.

19. The system of claim 15, wherein the operations further comprise:
discovering a new digital assistant in the group of digital assistants enabled for simultaneous execution on the MAD,
wherein the multi-assistant interface executes the warm word arbitration routine in response to discovering the new digital assistant in the group of digital assistants.

20. The system of claim 15, wherein the operations further comprise:
determining that a digital assistant has been removed from the group of digital assistants enabled for simultaneous execution on the MAD,
wherein the multi-assistant interface executes the warm word arbitration routine in response to determining that the digital assistant has been removed from the group of digital assistants.

21. The system of claim 15, wherein the operations further comprise, for a corresponding one of the digital assistants in the group of digital assistants:
determining an addition of a warm word or a removal of a warm word in the respective active set of warm words associated with the corresponding digital assistant,
wherein the multi-assistant interface executes the warm word arbitration routine in response to determining the addition of the warm word or the removal of the warm word in the respective set of warm words.

22. The system of claim 15, wherein the operations further comprise:
determining a change in ambient context,
wherein the multi-assistant interface executes the warm word arbitration routine in response to determining the change in ambient context.

23. The system of claim 15, wherein the operations further comprise:
obtaining enabled warm word constraints, the enabled warm word constraints comprising at least one of:
memory and computing resource availability on the MAD for detection of warm words;
computational requirements for enabling each warm word in respective active set of warm words associated with each respective digital assistant in the group of digital assistants;
an acceptable false accept rate tolerance; or
an acceptable false reject rate tolerance,
wherein a number of the warm words in the final set of warm words enabled for detection by the MAD is based on the obtained enabled warm word constraints.

24. The system of claim 15, wherein executing the warm word arbitration routine comprises:
identifying any shared warm words corresponding to warm words present in at least two of the active sets of warm words; and
determining the final set of warm words is based on assigning a higher priority to warm words identified as shared warm words.

25. The system of claim 15, wherein executing the warm word arbitration routine comprises:
for each warm word in the respective active set of warm words for each respective digital assistant in the group of digital assistants, determining a frequency of detection of the warm word by the MAD; and
determining the final set of warm words is based on the determined frequency of detection of each warm word in the respective active set of warm words for each respective digital assistant in the group of digital assistants.

26. The system of claim 15, wherein executing the warm word arbitration routine comprises:
for each warm word in the respective active set of warm words for each respective digital assistant in the group of digital assistants, determining a time when the warm word was most recently detected by the MAD; and
determining the final set of warm words is based on the determined time that each warm word in the respective active set of warm words for each respective digital assistant in the group of digital assistants was most recently detected.

27. The system of claim 15, wherein the operations further comprise:
receiving a voice command that commands the MAD to enable a first digital assistant and a second digital assistant to execute simultaneously on the MAD, the voice command spoken by a user of the MAD and captured by the MAD in streaming audio; and
after receiving the voice command, enabling the first digital assistant and the second digital assistant to execute simultaneously with one another on the MAD, wherein the group of digital assistants comprises the first digital assistant and the second digital assistant.

28. The system of claim 15, wherein the operations further comprise:
receiving, from a software application executing on the MAD or another device in communication with the MAD, a multi-assistant configuration request to enable a first digital assistant and a second digital assistant to execute simultaneously on the MAD; and
after receiving the multi-assistant configuration request, enabling the first digital assistant and the second digital assistant to execute simultaneously with one another on the MAD, wherein the group of digital assistants comprises the first digital assistant and the second digital assistant.
